(19) United States
(12) Patent Application Publication
(10) Pub. No.: US 2025/0162923 A1
(43) Pub. Date: May 22, 2025

(54) METHOD OF MANUFACTURING WINDOW

(71) Applicant: Samsung Display Co., LTD., Yongin-si (KR)

(72) Inventors: Kang Duk CHOI, Yongin-si (KR); Byoung Yul SHIM, Yongin-si (KR); Hyun Chul JUNG, Yongin-si (KR); Beom Gyu CHOI, Yongin-si, (KR)

(73) Assignee: Samsung Display Co., LTD., Yongin-si (KR)

(21) Appl. No.: 18/829,801

(22) Filed: Sep. 10, 2024

(30) Foreign Application Priority Data
Nov. 20, 2023 (KR) 10-2023-0161373

(51) Int. Cl. C03B 11/05; C03B 11/12; C03B 23/03

(52) U.S. Cl. CPC C03B 11/05; C03B 11/122; C03B 23/0302; C03B 23/0307

(57) ABSTRACT

A method of manufacturing a window includes a thermoforming step of pressurizing and thermoforming a first window disposed between a pressing frame and a receiving frame to form a second window, by moving the pressing frame in a first direction facing the receiving frame, wherein the first window includes a first flat portion, first curved portions bent at a curvature from the first flat portion, and a first corner portion between two adjacent first curved portions among the first curved portions, and the second window includes a second flat portion, second curved portions bent at a curvature from the second flat portion, and a second corner portion between two adjacent second curved portions among the second curved portions.

### CROSS REFERENCE TO RELATED APPLICATION(S)

This application claims priority to and benefits of Korean Patent Application No. 10-2023 -0161373 under 35 U.S.C. § 119, filed on Nov. 20, 2023, the entire content of which are incorporated herein by reference.

### BACKGROUND

### 1. Technical Field

Embodiments relate to a method of manufacturing a window. More specifically, embodiments relate to a method of manufacturing a window for a display device.

### 2. Description of the Related Art

Recently, demand for a display device that displays an image on not only a front surface but also a side surface is increasing. In order to implement such a display device, a window including a side surface including a curved surface of various shapes and a flat front surface is required to be provided. However, in case that the curved surface of various shapes is implemented on a side surface of the window, maintaining a uniform thickness on the side surface of the window becomes difficult, and thus a reliability reduction becomes a problem.

### SUMMARY

Embodiments provide a method of manufacturing a window capable of improving reliability.

According to embodiments, a method of manufacturing a window includes a thermoforming step of pressurizing and thermoforming a first window disposed between a pressing frame and a receiving frame to form a second window, by moving the pressing frame in a first direction toward the receiving frame. For example, the first window may include a first flat portion, first curved portions bent at a curvature from the first flat portion, and a first corner portion between two adjacent first curved portions among the first curved portions, and the second window may include a second flat portion, second curved portions bent at a curvature from the second flat portion, and a second corner portion between two adjacent second curved portions among the second curved portions. A first height of the first window may be defined as a height in the first direction from a first plane perpendicular to the first direction and measured from a front surface of the first flat portion to an edge portion of the first corner portion. A second height of the second window may be defined as a height in the first direction from a second plane perpendicular to the first direction and measured from a front surface of the second flat portion to an edge portion of the second corner portion. The first height of the first window may be equal to or greater than about 55% and equal to or less than about 85% of the second height of the second window.

In an embodiment, a length of a neutral surface profile of the first corner portion on a cross section may be equal to or greater than about 90% and equal to or less than about 110% of a length of the neutral surface profile of the second corner portion on a cross section.

In an embodiment, a first width of the neutral surface profile of the first corner portion in a second direction perpendicular to the first direction may be greater than a second width of the neutral surface profile of the second corner portion in the second direction.

In an embodiment, the first width of the neutral surface profile of the first corner portion may be equal to or greater than about 150% and equal to or less than about 250% of the first height of the first window.

In an embodiment, the second width of the neutral surface profile of the second corner portion may be equal to or greater than about 70% and equal to or less than about 130% of the second height of the second window.

In an embodiment, an average radius of curvature of the neutral surface profile of the first corner portion may be greater than an average radius of curvature of the neutral surface profile of the second corner portion.

In an embodiment, a thickness of the second corner portion on a cross section may gradually decrease and then gradually increase as a distance from the second flat portion increases.

In an embodiment, a minimum thickness of the second corner portion on a cross section may be equal to or greater than about 98% and equal to or less than about 99.9% of an average thickness of the second flat portion on a cross section.

In an embodiment, a maximum thickness of the second corner portion on a cross section may be equal to or greater than about 102% and equal to or less than about 105% of an average thickness of the second flat portion on a cross section.

In an embodiment, a length of an arc defined by an outer edge portion of the first corner portion in a plan view may be equal to or greater than about 101% and equal to or less than about 110% of a length of an arc defined by an outer edge portion of the second corner portion in a plan view.

In an embodiment, a thermoforming receiving space that is recessed in the first direction may be defined in the receiving frame, and the pressing frame may include a thermoforming protrusion protruding in the first direction.

In an embodiment, the thermoforming receiving space may have a shape corresponding to a front surface of the second window, and the thermoforming protrusion may have a shape corresponding to a rear surface of the second window.

In an embodiment, the method may further include a pre-thermoforming step of forming the first window by pressing and thermoforming a preliminary-window disposed between a pre-pressing frame and a pre-receiving frame, by moving the pre-pressing frame in the first direction toward the pre-receiving frame.

In an embodiment, each of a front surface and a rear surface of the preliminary-window may be a flat surface.

In an embodiment, the first height of the first window may be equal to or greater than about 200% and equal to or less than about 350% of an average thickness of the preliminary-window.

In an embodiment, a pre-thermoforming receiving space that is recessed in the first direction may be defined in the pre-receiving frame, and the pre-pressing frame may include a pre-thermoforming protrusion protruding in the first direction.

In an embodiment, the pre-thermoforming receiving space may have a shape corresponding to a front surface of the first window, and the pre-thermoforming protrusion may have a shape corresponding to a rear surface of the first window.

According to embodiments, a method of manufacturing a window may include: a first thermoforming step of forming a first curved window by pressing and thermoforming a flat window disposed between a first pressing frame and a first receiving frame, by moving the first pressing frame toward the first receiving frame; a second thermoforming step of pressurizing and thermoforming the first curved window disposed between a second pressing frame and a second receiving frame to form a second curved window, by moving the second pressing frame toward the second receiving frame, wherein the first curved window may include a first flat portion, first curved portions bent at a first curvature from the first flat portion, and a first corner portion between two adjacent first curved portions among the first curved portions, the second curved window may include a second flat portion, second curved portions bent at a second curvature from the second flat portion, and a second corner portion between two adjacent second curved portions among the second curved portions, and the first curvature of each first curved portion of the first curved window may be smaller than the second curvature of each second curved portion of the second curved window.

In an embodiment, a first height of the first curved window measured from the first flat portion may be smaller than a second height of the second curved window measured from the second flat portion.

In an embodiment, the first height of the first curved window may be equal to or greater than about 55% and equal to or less than about 85% of the second height of the second curved window.

The method of manufacturing the window according to embodiments forms the second window by pressure thermoforming of the first window. Accordingly, reliability of the second window may be further improved compared to a case where the second window is formed from a preliminary-window. Here, a content for the preliminary-window, the first window, and the second window refers to a content described in this specification.

### BRIEF DESCRIPTION OF THE DRAWINGS

The above and other features of the disclosure will become more apparent by describing in further detail embodiments thereof with reference to the accompanying drawings, in which:

FIG. 1 is a diagram illustrating a method of manufacturing a window according to an embodiment;

FIG. 2 is a schematic perspective view illustrating a pre-thermoforming device for performing a pre-thermoforming step S0 of FIG. 1;

FIG. 3 is a schematic cross-sectional view illustrating the pre-thermoforming step S0 of FIG. 1;

FIGS. 4, 5, and 6 are schematic diagrams illustrating a first window formed by the pre-thermoforming step S0 of FIG. 1;

FIG. 7 is a schematic perspective view illustrating a thermoforming device for performing a thermoforming step S1 of FIG. 1;

FIG. 8 is a schematic cross-sectional view illustrating the thermoforming step S1 of FIG. 1;

FIGS. 9, 10, and 11 are schematic diagrams illustrating a second window formed by the thermoforming step S1 of FIG. 1;

FIG. 12 is a schematic diagram illustrating a display device including the second window of FIG. 9;

FIG. 13 is a diagram illustrating a simulation result according to an embodiment;

FIG. 14 is a diagram illustrating a simulation result according to a comparative example; and

FIG. 15 is a diagram illustrating a simulation result of FIGS. 13 and 14.

### DETAILED DESCRIPTION OF THE EMBODIMENT

In the following description, for the purposes of explanation, numerous specific details are set forth in order to provide a thorough understanding of various embodiments or implementations of the invention. As used herein, “embodiments” and “implementations” are interchangeable words that are non-limiting examples of devices or methods disclosed herein. It is apparent, however, that various embodiments may be practiced without these specific details or with one or more equivalent arrangements. Here, various embodiments do not have to be exclusive nor limit the disclosure. For example, specific shapes, configurations, and characteristics of an embodiment may be used or implemented in another embodiment.

Unless otherwise specified, the illustrated embodiments are to be understood as providing features of the invention. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the scope of the invention.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element or a layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another clement or layer, there are no intervening elements or layers present. To this end, the term “connected” may refer to physical, electrical, and/or fluid connection, with or without intervening elements. Further, the axis of the first direction DR1, the axis of the second direction DR2, and the axis of the third direction DR3 are not limited to three axes of a rectangular coordinate system, such as the X, Y, and Z—axes, and may be interpreted in a broader sense. For example, the axis of the first direction DR1, the axis of the second direction DR2, and the axis of the third direction DR3 may be perpendicular to one another, or may represent different directions that are not perpendicular to one another. For the purposes of this disclosure, “at least one of A and B” may be understood to mean A only, B only, or any combination of A and B. Also, “at least one of X, Y, and Z” and “at least one selected from the group consisting of X, Y, and Z” may be construed as X only, Y only, Z only, or any combination of two or more of X, Y, and Z. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one element's relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the term “below” can encompass both an orientation of above and below. Furthermore, the apparatus may be otherwise oriented (e.g., rotated 90 degrees or at other orientations), and, as such, the spatially relative descriptors used herein should be interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the invention. Further, the blocks, units, and/or modules of some embodiments may be physically combined into more complex blocks, units, and/or modules without departing from the scope of the invention.

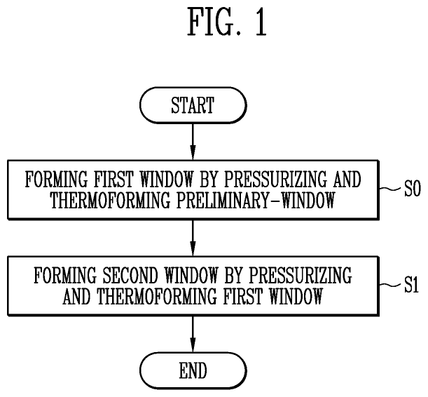

FIG. 1 is a diagram illustrating a method of manufacturing a window according to an embodiment.

Referring to FIG. 1, the method of manufacturing the window according to an embodiment may include a pre-thermoforming step S0 of forming a first window by pressurizing and thermoforming a preliminary-window, and a thermoforming step S1 of forming a second window by pressurizing and thermoforming the first window.

For example, each of the first window and the second window may include a side surface including a curved surface of various shapes, and the preliminary-window may be substantially flat.

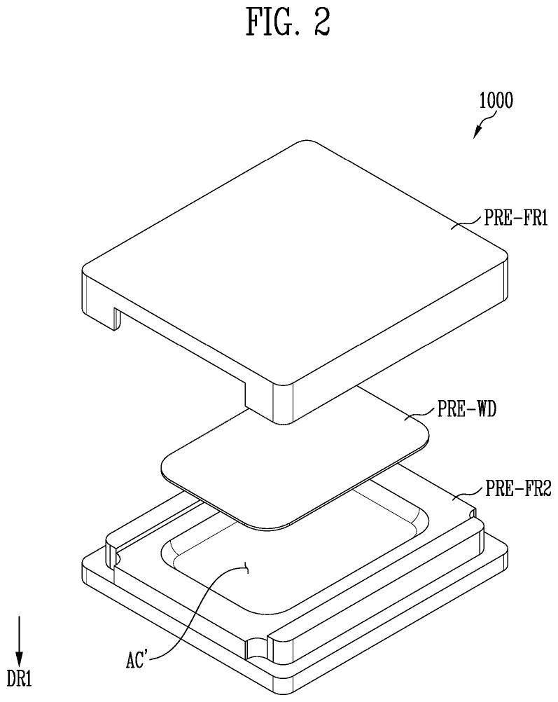

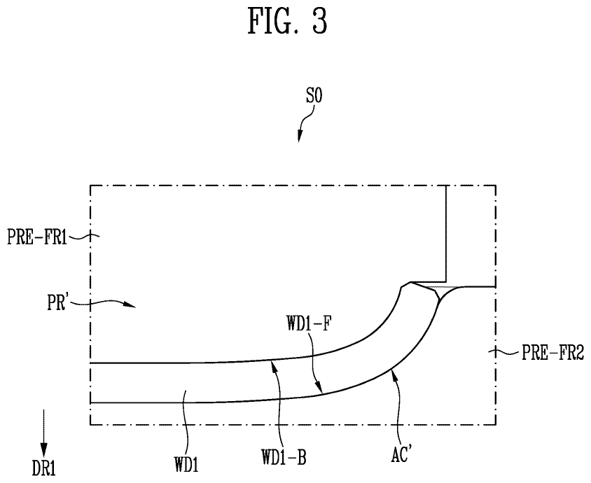

FIG. 2 is a schematic perspective view illustrating a pre-thermoforming device for performing the pre-thermoforming step S0 of FIG. 1, and FIG. 3 is a schematic cross-sectional view illustrating the pre-thermoforming step S0 of FIG. 1.

Referring to FIG. 2, the pre-thermoforming device 1000 may include a pre-pressing frame PRE-FR1 and a pre-receiving frame PRE-FR2 positioned opposite to the pre-pressing frame PRE-FR1.

The pre-pressing frame PRE-FR1 may relatively move in a first direction DR1 toward the pre-receiving frame PRE-FR2. Accordingly, a preliminary-window PRE-WD disposed between the pre-pressing frame PRE-FR1 and the pre-receiving frame PRE-FR2 may be pressurized.

As shown in FIG. 2, the preliminary-window PRE-WD may be substantially flat. For example, each of a front surface and a rear surface of the preliminary-window PRE-WD may be a flat surface.

Referring to FIGS. 2 and 3, sufficient heat may be supplied to the preliminary-window with pressing the preliminary-window PRE-WD by the pre-pressing frame PRE-FR1 and the pre-receiving frame PRE-FR2. A first window WD1 having a curved surface in a partial area may be formed (in the pre-thermoforming step S0), by pressurizing and thermoforming the preliminary-window PRE-WD.

In an embodiment, a pre-thermoforming receiving space AC′, which is recessed toward the first direction DR1, may be defined in the pre-receiving frame PRE-FR2, and the pre-pressing frame PRE-FR1 may include a pre-thermoforming protrusion PR′ protruding toward the first direction DR1. For example, the pre-thermoforming receiving space AC′ may have a shape corresponding to a front surface WD1-F of the first window WD1, and the pre-thermoforming protrusion PR′ may have a shape corresponding to a rear surface WD1-B of the first window WD1.

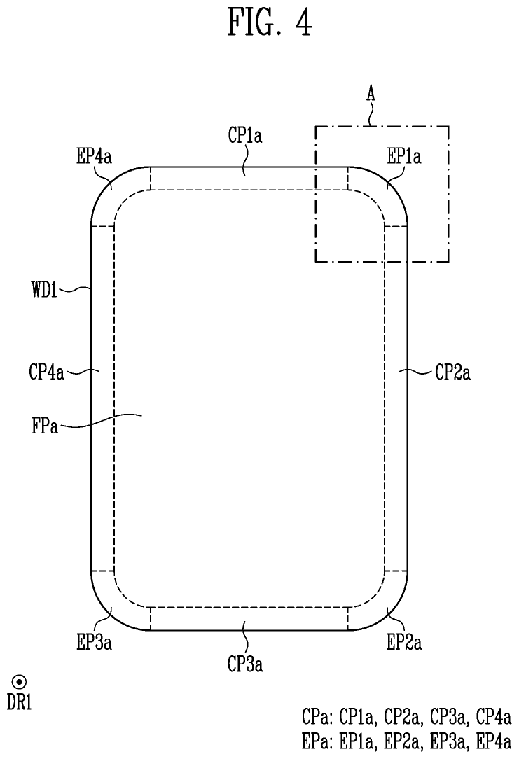

Hereinafter, the first window WD1 formed by the pre-thermoforming step S0 is described in more detail with reference to FIGS. 4 to 6.

FIG. 4 is a schematic plan view illustrating the front surface of the first window WD1 as viewed from the first direction DR1.

Referring to FIG. 4, the first window WD1 may include a first flat portion FPa, first curved portions CPa bent at a curvature from the first flat portion FPa, and a first corner portion EPa between two adjacent first curved portions CPa among the first curved portions CPa.

The first flat portion FPa may be substantially flat. For example, each of a front surface and a rear surface of the first flat portion FPa may be a flat surface. For example, each of the front surface and the rear surface of the first flat portion FPa may be perpendicular to the first direction DR1.

The first curved portions CPa may include four curved portions CP1a, CP2a, CP3a, and CP4a. Each of the four curved portions CP1a, CP2a, CP3a, and CP4a may contact at least one side of the first flat portion FPa and may be bent at a curvature from the first flat portion FPa.

The first corner portion EPa may include four corner portions EP1a, EP2a, EP3a, and EP4a. The corner portion EP1a may be positioned between the curved portion CP1a and the curved portion CP2a, the corner portion EP2a may be positioned between the curved portion CP2a and the curved portion CP3a, the corner portion EP3a may be positioned between the curved portion CP3a and the curved portion CP4a, and the corner portion EP4a may be positioned between the curved portion CP4a and the curved portion CP1a. For example, each of the four corner portions EP1a, EP2a, EP3a, and EP4a may be positioned adjacent to a corner portion of the first flat portion FPa.

The first corner portion EPa may also be bent at a curvature from the first flat portion FPa, similarly to the first curved portions CPa. For example, portions bent to have a curvature, such as the first curved portions CPa and the first corner portion EPa, may be formed by the pre-thermoforming step S0 described with reference to FIGS. 1 to 3.

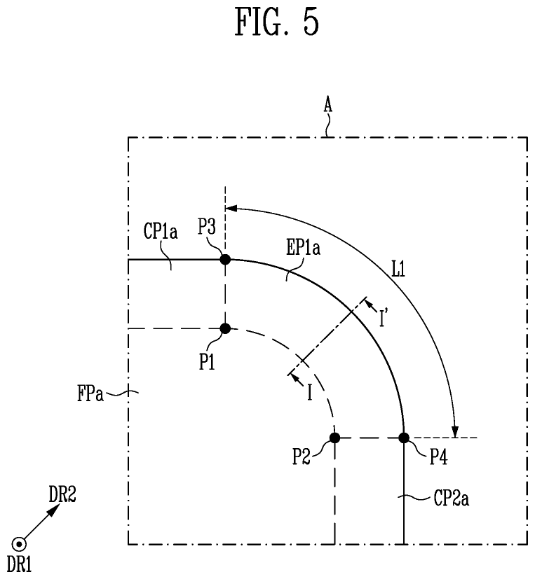

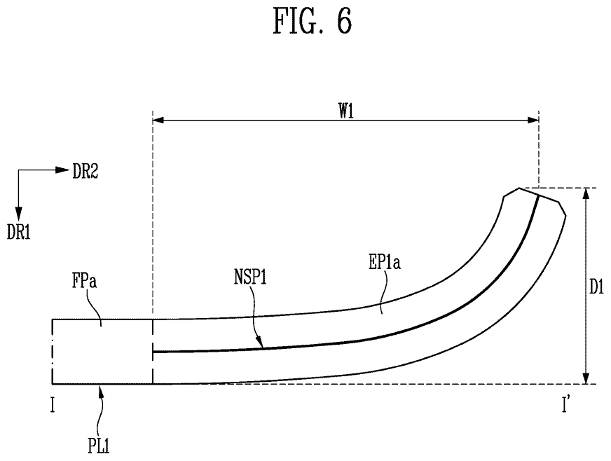

Hereinafter, a shape of the first corner portion EPa of the first window WD1 is described in more detail with reference to FIGS. 5 and 6.

For example, in the first corner portion EPa of the first window WD1, the corner portion EP1a may have a symmetrical relationship with the corner portions EP2a, EP3a, and EP4a, and a shape of the corner portion EP1a may be substantially equal or similar to a shape of each of the corner portions EP2a, EP3a, and EP4a. Therefore, hereinafter, for convenience of description, the disclosure is described based on the corner portion EP1a, and a description below may be applied substantially equally or similarly to the corner portions EP2a, EP3a, and EP4a.

FIG. 5 is an enlarged schematic plan view of an area A of FIG. 4.

Referring to FIG. 5, an arc defined by an outer edge portion of the corner portion EP1a in a plan view may have a first length L1. For example, the arc connecting a point P3 and a point P4 may have the first length L1.

FIG. 6 is a schematic cross-sectional view taken along line I-I′ of FIG. 5.

The line I-I′ here is a line passing through each of a bisector point of an arc defined by an inner edge portion of the corner portion EP1a that is in contact with the first flat portion FPa (e.g., an arc shown in a dotted line to connect the point P1 and the point P2 in FIG. 5) and a bisector point of an arc defined by an outer edge portion of the corner portion EP1a (e.g., an arc shown in a solid line to connect the point P3 and the point P4 in FIG. 5), and is a line parallel to a second direction DR2 which is perpendicular to the first direction DR1.

Referring to FIG. 6, a first height D1 of the first window WD1 may be defined as a height in the first direction DR1 from a first plane PL1 to an edge portion of the corner portion EP1a. The first plane PL1 may be a plane extending from a front surface of the first flat portion FPa and may be perpendicular to the first direction DR1. For example, a distance in the first direction DR1 between the edge portion of the corner portion EP1a (e.g., the farthest end portion or highest end portion from the first plane PL1) and the first plane PL1 may be defined as the first height D1 of the first window WD1.

For example, a neutral surface profile (or neutral plane profile) NSP1 of the corner portion EP1a on a cross section may be defined. For example, the neutral surface (or neutral plane) may mean a surface that does not receive compression and tension (e.g., a surface that does not expand or contract or is not under stress) in the corner portion EP1a. For example, a first width W1 which is a width of the neutral surface profile NSP1 on the cross section in the second direction DR2 may be defined.

In an embodiment, an average radius of curvature of the neutral surface profile NSP1 of the corner portion EP1a on the cross section may be relatively great. For example, the first width W1 of the neutral surface profile NSP1 may be greater than the first height D1 of the first window WD1. For example, the first width W1 of the neutral surface profile NSP1 may be equal to or greater than about 150% and equal to or less than about 250% of the first height D1 of the first window WD1.

As described above, as the average radius of curvature of the neutral surface profile NSP1 of the corner portion EP1a is formed to be relatively great, the corner portion EP1a may be relatively less curved compared to the corner portion EP1b of the second window WD2, which will be described later. This may mean that in case of performing pressure thermoforming for forming the corner portion EP1a of the first window WD1 in the above-described pre-thermoforming step S0, tensile force and/or compression force applied to the corner portion EP1a may be relatively small.

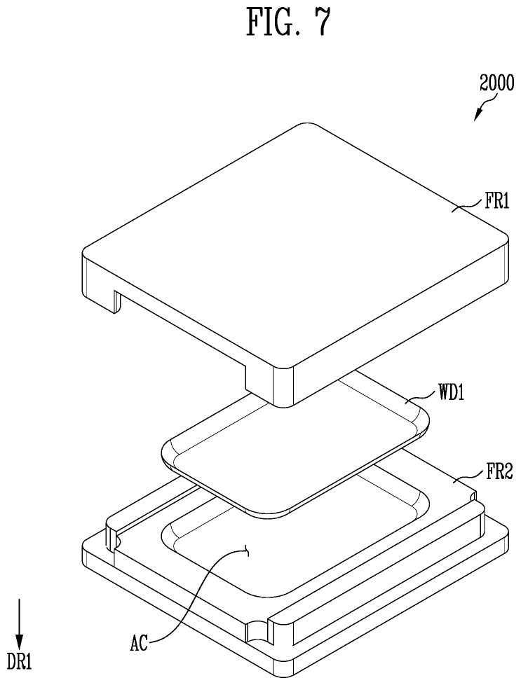

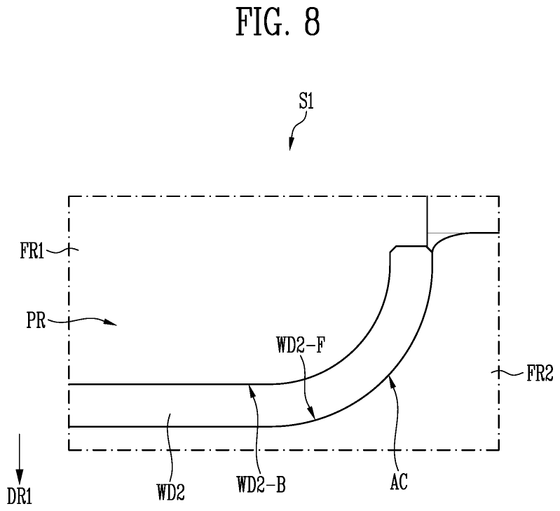

FIG. 7 is a schematic perspective view illustrating a thermoforming device for performing the thermoforming step S1 of FIG. 1, and FIG. 8 is a schematic cross-sectional view illustrating the thermoforming step S1 of FIG. 1.

Referring to FIG. 7, the thermoforming device 2000 may include a pressing frame FR1 and a receiving frame FR2 disposed opposite to the pressing frame FR1.

The pressing frame FR1 may relatively move in the first direction DR1 toward the receiving frame FR2. Accordingly, the first window WD1 disposed between the pressing frame FR1 and the receiving frame FR2 may be pressed.

As shown in FIG. 7, the front surface of the first window WD1 may be disposed in a direction toward the receiving frame FR2, and the rear surface of the first window WD1 may be disposed in a direction toward the pressing frame FR2.

Referring to FIGS. 7 and 8, sufficient heat may be supplied to the first window WD1 with pressing the first window WD1 by the pressing frame FR1 and the receiving frame FR2. The second window WD2 may be formed by pressure thermoforming of the first window WD1 (e.g., in the thermoforming step S1).

In an embodiment, a thermoforming receiving space AC that is recessed toward the first direction DR1 may be defined in the receiving frame FR2, and the pressing frame FR1 may include a thermoforming protrusion PR protruding toward the first direction DR1. For example, the thermoforming receiving space AC may have a shape corresponding to a front surface WD2-F of the second window WD2, and the thermoforming protrusion PR may have a shape corresponding to a rear surface WD2-B of the second window WD2.

For example, referring to FIG. 3, compared to the depth in the first direction DR1 of the pre-thermoforming receiving space AC′, a depth in the first direction DR1 of the thermoforming receiving space AC may be greater. Similarly, compared to the thickness in the first direction DR1 of the pre-thermoforming protrusion PR′, a thickness in the first direction DR1 of the thermoforming protrusion PR may be greater.

Accordingly, as will be described later, compared to an average radius of curvature of a portion bent at a curvature of the first window WD1, an average radius of curvature of a portion bent at a curvature of the second window WD2 may be less. For example, compared to the portion bent at the curvature of the first window WD1, the portion bent at the curvature of the second window WD2 may be relatively more curved.

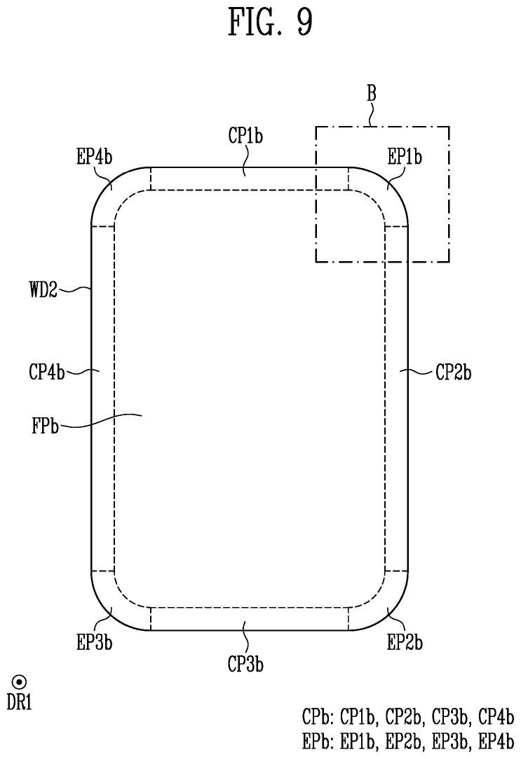

Hereinafter, the second window WD2 formed by the thermoforming step S1 is described in more detail with reference to FIGS. 9 to 11.

FIG. 9 is a schematic plan view illustrating the front surface of the second window WD2 as viewed from the first direction DR1.

Referring to FIG. 9, the second window WD2 may include a second flat portion FPb, second curved portions CPb bent at a curvature from the second flat portion FPb, and a second corner portion EPb between two adjacent second curved portions CPb among the second curved portions CPb.

The second flat portion FPb may be substantially flat. For example, each of a front surface and a rear surface of the second flat portion FPb may be a flat surface. For example, each of the front surface and the rear surface of the second flat portion FPb may be perpendicular to the first direction DR1.

The second curved portions CPb may include four curved portions CP1b, CP2b, CP3b, and CP4b. Each of the four curved portions CP1b, CP2b, CP3b, and CP4b may be in contact with at least one side of the second flat portion FPb and may be bent at a curvature from the second flat portion FPb.

The second corner portion EPb may include four corner portions EP1b, EP2b, EP3b, and EP4b. The corner portion EP1b may be positioned between the curved portion CP1b and the curved portion CP2b, the corner portion EP2b may be positioned between the curved portion CP2b and the curved portion CP3b, the corner portion EP3b may be positioned between the curved portion CP3b and the curved portion CP4b, and the corner portion EP4b may be positioned between the curved portion CP4b and the curved portion CP1b. For example, each of the four corner portions EP1b, EP2b, EP3b, and EP4b may be positioned adjacent to a corner portion of the second flat portion FPb.

The second corner portion EPb may also be bent at a curvature from the second flat portion FPb, similarly to the second curved portions CPb. For example, portions bent to have a curvature, such as the second curved portions CPb and the second corner portion EPb, may be formed by the thermoforming step S1 described with reference to FIGS. 1 and 7 to 8.

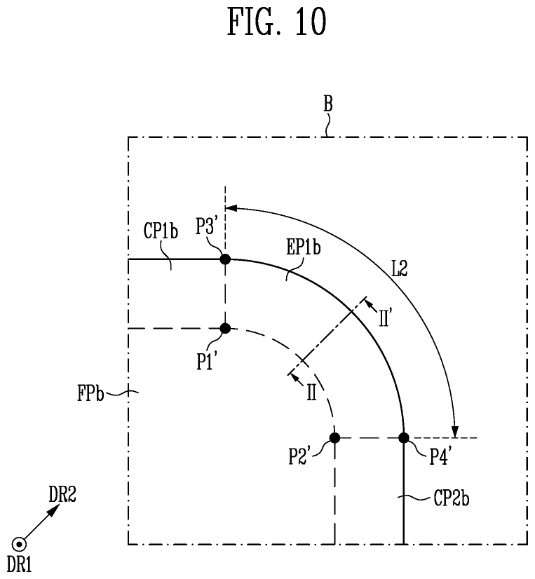

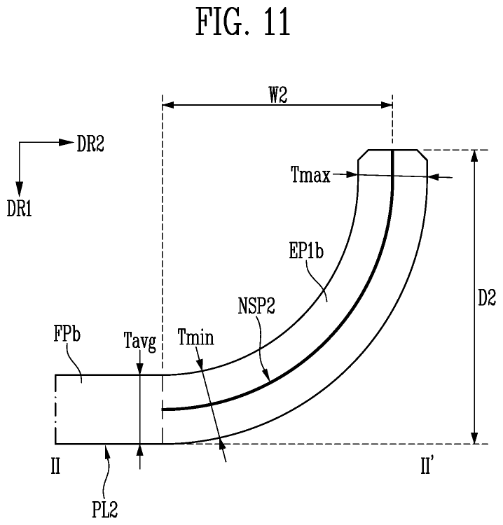

Hereinafter, a shape of the second corner portion EPb of the second window WD2 is described in more detail with reference to FIGS. 10 and 11.

For example, in the second corner portion EPb of the second window WD2, the corner portion EP1b may have a symmetrical relationship with the corner portions EP2b, EP3b, and EP4b, and a shape of the corner portion EP1b may be substantially equal or similar to a shape of each of the corner portions EP2b, EP3b, and EP4b. Therefore, hereinafter, for convenience of description, the disclosure is described based on the corner portion EP1b, and a description below may be applied substantially equally or similarly to the corner portions EP2b, EP3b, and EP4b.

FIG. 10 is an enlarged schematic plan view of an area B of FIG. 9.

Referring to FIG. 10, an arc defined by an outer edge portion of the corner portion EP1b in a plan view may have a second length L2. For example, the arc connecting a point P3′ and a point P4′ may have the second length L2.

FIG. 11 is a schematic cross-sectional view taken along line II-II′ of FIG. 10.

The line II-II′ is a line passing through each of a bisector point of an arc defined by an inner edge portion of the corner portion EP1b that is in contact with the second flat portion FPb (e.g., an arc depicted with a dotted line to connect the point P1′ and the point P2′ in FIG. 10) and a bisector point of an arc defined by an outer edge portion of the corner portion EP1b (for example, an arc depicted with a solid line to connect the point P3′ and the point P4′ in FIG. 10), and is a line parallel to the second direction DR2.

Referring to FIG. 11, a second height D2 of the second window WD2 may be defined as a height in the first direction DR1 from a second plane PL2 to an edge portion of the corner portion EP1b. The second plane PL2 may be a plane extending from a front surface of the second flat portion FPb and may be perpendicular to the first direction DR1.

For example, a neutral surface profile (or neutral plane profile) NSP2 of the corner portion EP1b on a cross section may be defined. For example, the neutral surface (or neutral plane) may mean a surface that does not receive compression and tension (for example, a surface that does not expand or contract or is not under stress) in the corner portion EP1b. For example, a second width W2 which is a width of the neutral surface profile NSP2 of the corner portion EP1b on the cross section in the second direction DR2 may be defined.

In an embodiment, an average radius of curvature of the neutral surface profile NSP2 of the corner portion EP1b on the cross section may be relatively small. For example, the second width W2 of the neutral surface profile NSP2 may be equal to or greater than about 70% and equal to or less than about 130% of the second height D2 of the second window WD2. For example, compared to the average radius of curvature of the neutral surface profile of the corner portion EP1b of FIG. 11, the average radius of curvature of the neutral surface profile NSP1 of the corner portion EP1a of FIG. 6 may be greater. For example, the corner portion EP1b of FIG. 11 may be relatively more curved compared to the corner portion EP1a of FIG. 6.

As described above, in case of forming the first window WD1 including the relatively less curved corner portion EP1a of FIG. 6 by pressure thermoforming of the preliminary-window PRE-WD (e.g., in the pre-thermoforming step S0), and forming the second window WD2 including a relatively more curved corner portion EP1b by pressure thermoforming of the first window WD1, tensile force and/or compression force applied to the corner portion EP1b of the second window WD2 may be relatively small compared to a case where directly forming the second window WD2 by pressure thermoforming of the preliminary-window PRE-WD. Accordingly, a thickness change at the corner portion EP1b of the second window WD2 may be relatively small, and sufficient reliability may be ensured at the corner portion EP1b of the second window WD2.

Hereinafter, with reference to FIGS. 4 to 6 and 9 to 11, various embodiments for ensuring sufficient reliability at the second corner portion EPb of the second window WD2 are described.

In an embodiment, the first height D1 of the first window WD1 of FIG. 6 may be equal to or greater than about 55% and equal to or less than about 85% of the second height D2 of the second window WD2 of FIG. 11, and may be equal to or greater than about 65% and equal to or less than about 75% of the second height D2 of the second window WD2 of FIG. 11. For example, in case that the first height D1 of the first window WD1 satisfies the above-described range, tensile force and/or compression force applied to the first corner portion EPa of the first window WD1 in case of performing the pre-thermoforming step S0 may be relatively small, and tensile force and/or compression force applied to the second corner portion EPb of the second window WD2 in case of performing the thermoforming step S1 may also be relatively small.

In an embodiment, a total length of the neutral surface profile (for example, NSP1 of FIG. 6) of the first corner portion EPa may be equal to or greater than about 90% and equal to or less than about 110% of a total length of the neutral surface profile (for example, NSP2 of FIG. 11) of the second corner portion EPb. For example, the total length of the neutral surface profile (for example, NSP1 of FIG. 6) of the first corner portion EPa may be equal to or greater than about 95% and equal to or less than about 105% of the total length of the neutral surface profile (for example, NSP2 of FIG. 11) of the second corner portion EPb. As described above, in case that the total length of the neutral surface profile on the cross section of the first corner portion EPa is substantially similar to the total length of the neutral surface profile on the cross section of the second corner portion EPb, a burr or unfilling may not occur in the second corner portion EPb of the second window WD2 after performing the thermoforming step S1.

In an embodiment, the first width W1 of the neutral surface profile NSP1 of FIG. 6 may be greater than the second width W2 of the neutral surface profile NSP2 of FIG. 11. As described above, in case that the first width W1 of the neutral surface profile NSP1 is greater than the second width W2 of the neutral surface profile NSP2, tensile force and/or compression force applied to the first corner portion EPa of the first window WD1 in case of performing the pre-thermoforming step S0 may be relatively small, tensile force and/or compression force applied to the second corner portion EPb of the second window WD2 in case of performing the thermoforming step S1 may also be relatively small.

In an embodiment, the first height D1 of the first window WD1 of FIG. 6 may be equal to or greater than about 200% and equal to or less than about 350% of an average thickness of the preliminary-window PRE-WD. For example, the first height D1 of the first window WD1 of FIG. 6 may be equal to or greater than about 260% and equal to or less than about 320% of the average thickness of the preliminary-window PRE-WD. For example, in case that the first height D1 of the first window WD1 satisfies the above-described range, tensile force and/or compression force applied to the first corner portion EPa of the first window WD1 in case of performing the pre-thermoforming step S0 may be relatively small.

In an embodiment, the first length L1 of FIG. 5 may be greater than the second length L2 of FIG. 10. For example, the first length L1 of FIG. 5 may be equal to or greater than about 101% and equal to or less than about 110% of the second length L2 of FIG. 10.

As described above, in case of forming the second window WD2 by performing at least two multi-step thermoforming steps S0 and S1, reliability in the second corner portion EPb of the second window WD2 may be improved. For example, the second corner portion EPb of the second window WD2 may be formed to be sufficiently curved, and a thickness of the second corner portion EPb of the second window WD2 may be relatively uniform.

For example, referring to FIG. 11, a thickness of the corner portion EP1b of the second window WD2 on the cross section may gradually decrease and then gradually increase as a distance from the second flat portion FPb increases. For example, the thickness at the corner portion EP1b may be relatively uniform.

In an embodiment, a minimum thickness Tmin of the corner portion EP1b of the second window WD2 on the cross section may be equal to or greater than about 98% and equal to or less than about 99.9% of an average thickness Tavg of the second flat portion FPb on the cross section. For example, a maximum thickness Tmax of the corner portion EP1b of the second window WD2 on the cross section may be equal to or greater than about 102% and equal to or less than about 105% of the average thickness Tavg of the second flat portion FPb on the cross section.

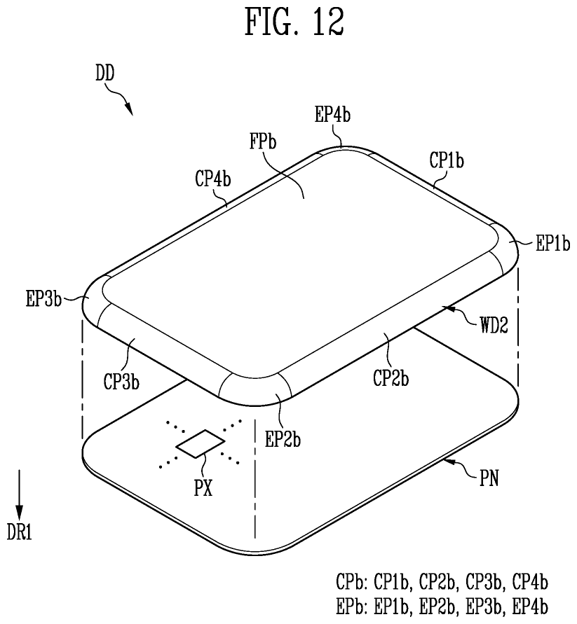

FIG. 12 is a schematic diagram illustrating a display device including the second window of FIG. 9.

Referring to FIG. 12, the second window WD2 may be applied to the display device DD.

For example, the display device DD may include a display panel PN and the second window WD2.

The display panel PN may include pixels PX, and each of the pixels PX may emit light. For example, an image may be displayed by a combination of light emitted from the pixels PX.

The display panel PN may be attached to the rear surface of the second window WD2. Accordingly, at least a portion of the display panel PN may be curved in correspondence with a shape of the second flat portion FPb, the second curved portions CPb, and the second corner portion EPb of the second window WD2. For example, a user viewing the display device DD through the front surface of the second window WD2 may view an image displayed through each of the second flat portion FPb, the second curved portions CPb, and the second corner portion EPb of the second window WD2.

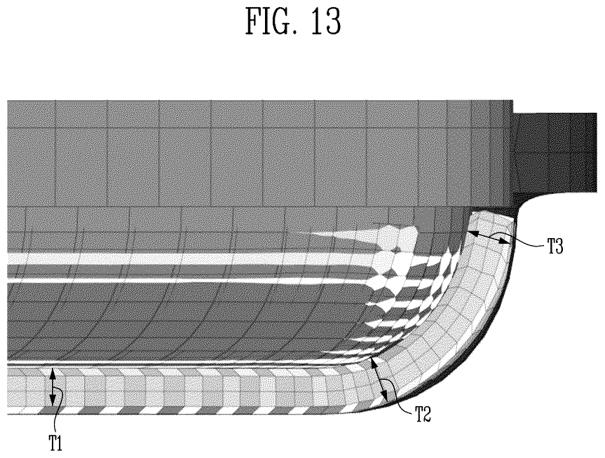

FIG. 13 is a diagram illustrating a simulation result according to an embodiment.

Referring to FIG. 13, a simulation of forming the second window WD2 by pressurizing and thermoforming the first window WD1 (e.g., in the thermoforming step S1) after forming the first window WD1 by pressurizing and thermoforming the preliminary-window PRE-WD (e.g., in the pre-thermoforming step S0) is performed, and a configuration (or structure) in which the formed second window WD2 is interposed between the pressing frame FR1 and the receiving frame FR2 is shown in FIG. 13. For example, the simulation is implemented so that each of the preliminary-window PRE-WD, the first window WD1, and the second window WD2 may satisfy the above description.

In the simulation result according to an embodiment, an average thickness T1 at the second flat portion FPb of the second window WD2 is about 0.6 mm, a minimum thickness T2 at the second corner portion EPb is about 0.592 mm, and a maximum thickness T3 at the second corner portion EPb is about 0.619 mm. For example, the minimum thickness T2 is about 98.67% of the average thickness T1, and the maximum thickness T3 is about 103.17% of the average thickness T1.

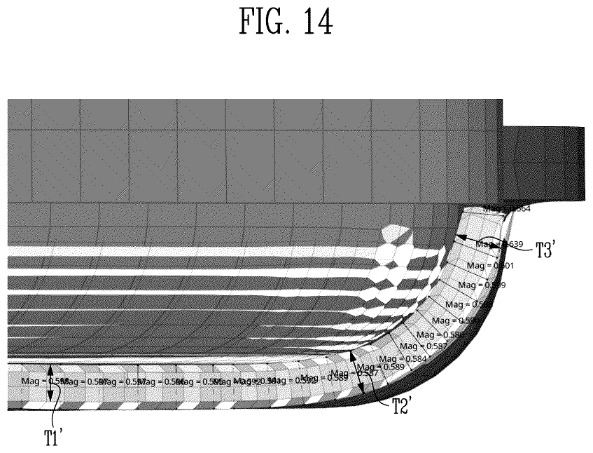

FIG. 14 is a diagram illustrating a simulation result according to a comparative example.

Referring to FIG. 14, a simulation of directly forming the second window WD2 by pressurizing and thermoforming the preliminary-window PRE-WD using the pressing frame FR1 and the receiving frame FR2 is performed, and an aspect in which the formed second window WD2 is interposed between the pressing frame FR1 and the receiving frame FR2 is shown in FIG. 14.

In the simulation result according to the comparative example, an average thickness T1′ at the second flat portion FPb of the second window WD2 is about 0.6 mm, a minimum thickness T2′ at the second corner portion EPb is about 0.584 mm, and a maximum thickness T3′ at the second corner portion EPb is about 0.639 mm. For example, the minimum thickness T2 is about 97.33% of the average thickness T1, and the maximum thickness T3 is about 106.5% of the average thickness T1. From this, compared to the simulation result according to an embodiment, it may be seen that thickness uniformity in the second corner portion EPb is inferior.

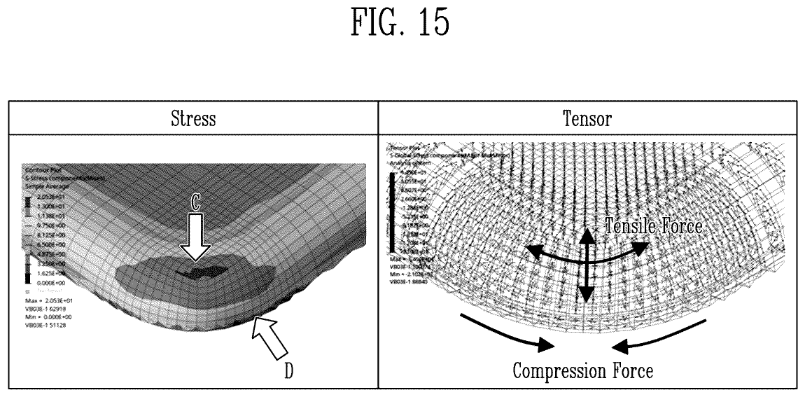

FIG. 15 is a diagram illustrating a simulation result of FIGS. 13 and 14.

Referring to FIG. 15, in case of forming a corner portion by performing pressure thermoforming, tensile force may act (or be applied) in an area C of the corner portion and compression force may act in an area D. For example, the tensile force acting in the area C of the corner portion may cause a thickness decrease in the area C, and the compression force acting in the area D may cause a thickness increase in the area D.

For example, a magnitude of each of the tensile force acting on the area C and the compression force acting on the area D may be generally proportional to a deformation degree of a shape of a window in case of performing pressure thermoforming.

For example, in case of forming the second window WD2 through the two steps of pressure thermoforming as in the simulation described with reference to FIG. 13, a shape deformation degree of the window in each pressure thermoforming step may be relatively small, and thus each of the above-described tensile force and compression force may be minimized. For example, as the tensile force in the area C is minimized, the amount of thickness decrease in the area C may be minimized, and as the compression force in the area D is minimized, the amount of thickness increase in the area D may be minimized.

In case that the second window WD2 is formed by one-time pressure thermoforming as in the simulation described with reference to FIG. 14, a shape deformation degree of the window becomes relatively large, and thus each of the above-described tensile force and compression force may be relatively large. For example, the amount of the thickness decrease in the area C may be relatively large, and the amount of the thickness increase in the area D may be relatively large.

Although the disclosure is described with reference to the above embodiments, those skilled in the art will understand that the disclosure may be variously corrected and changed without departing from the spirit and scope of the disclosure as set forth in the claims below.

What is claimed is:

1. A method of manufacturing a window, the method comprising:
a thermoforming step of pressurizing and thermoforming a first window disposed between a pressing frame and a receiving frame to form a second window, by moving the pressing frame in a first direction toward the receiving frame, wherein
the first window includes a first flat portion, first curved portions bent at a curvature from the first flat portion, and a first corner portion between two adjacent first curved portions among the first curved portions,
the second window includes a second flat portion, second curved portions bent at a curvature from the second flat portion, and a second corner portion between two adjacent second curved portions among the second curved portions,
a first height of the first window is defined as a height in the first direction from a first plane perpendicular to the first direction and measured from a front surface of the first flat portion to an edge portion of the first corner portion,
a second height of the second window is defined as a height in the first direction from a second plane perpendicular to the first direction and measured from a front surface of the second flat portion to an edge portion of the second corner portion, and
the first height of the first window is equal to or greater than about 55% and equal to or less than about 85% of the second height of the second window.

2. The method according to claim 1, wherein a length of a neutral surface profile of the first corner portion on a cross section is equal to or greater than about 90% and equal to or less than about 110% of a length of the neutral surface profile of the second corner portion on a cross section.

3. The method according to claim 2, wherein a first width of the neutral surface profile of the first corner portion in a second direction perpendicular to the first direction is greater than a second width of the neutral surface profile of the second corner portion in the second direction.

4. The method according to claim 3, wherein the first width of the neutral surface profile of the first corner portion is equal to or greater than about 150% and equal to or less than about 250% of the first height of the first window.

5. The method according to claim 3, wherein the second width of the neutral surface profile of the second corner portion is equal to or greater than about 70% and equal to or less than about 130% of the second height of the second window.

6. The method according to claim 2, wherein an average radius of curvature of the neutral surface profile of the first corner portion is greater than an average radius of curvature of the neutral surface profile of the second corner portion.

7. The method according to claim 1, wherein a thickness of the second corner portion on a cross section gradually decreases and then gradually increases as a distance from the second flat portion increases.

8. The method according to claim 7, wherein a minimum thickness of the second corner portion on a cross section is equal to or greater than about 98% and equal to or less than about 99.9% of an average thickness of the second flat portion on a cross section.

9. The method according to claim 7, wherein a maximum thickness of the second corner portion on a cross section is equal to or greater than about 102% and equal to or less than about 105% of an average thickness of the second flat portion on a cross section.

10. The method according to claim 1, wherein a length of an arc defined by an outer edge portion of the first corner portion in a plan view is equal to or greater than about 101% and equal to or less than about 110% of a length of an arc defined by an outer edge portion of the second corner portion in a plan view.

11. The method according to claim 1, wherein
a thermoforming receiving space that is recessed in the first direction is defined in the receiving frame, and
the pressing frame includes a thermoforming protrusion protruding in the first direction.

12. The method according to claim 11, wherein
the thermoforming receiving space has a shape corresponding to a front surface of the second window, and
the thermoforming protrusion has a shape corresponding to a rear surface of the second window.

13. The method according to claim 1, further comprising:
a pre-thermoforming step of forming the first window by pressing and thermoforming a preliminary-window disposed between a pre-pressing frame and a pre-receiving frame, by moving the pre-pressing frame in the first direction toward the pre-receiving frame.

14. The method according to claim 13, wherein each of a front surface and a rear surface of the preliminary-window is a flat surface.

15. The method according to claim 13, wherein the first height of the first window is equal to or greater than about 200% and equal to or less than about 350% of an average thickness of the preliminary-window.

16. The method according to claim 13, wherein
a pre-thermoforming receiving space that is recessed in the first direction is defined in the pre-receiving frame, and
the pre-pressing frame includes a pre-thermoforming protrusion protruding in the first direction.

17. The method according to claim 16, wherein
the pre-thermoforming receiving space has a shape corresponding to a front surface of the first window, and
the pre-thermoforming protrusion has a shape corresponding to a rear surface of the first window.

18. A method of manufacturing a window, the method comprising:
a first thermoforming step of forming a first curved window by pressing and thermoforming a flat window disposed between a first pressing frame and a first receiving frame, by moving the first pressing frame toward the first receiving frame;
a second thermoforming step of pressurizing and thermoforming the first curved window disposed between a second pressing frame and a second receiving frame to form a second curved window, by moving the second pressing frame toward the second receiving frame, wherein
the first curved window includes a first flat portion, first curved portions bent at a first curvature from the first flat portion, and a first corner portion between two adjacent first curved portions among the first curved portions,
the second curved window includes a second flat portion, second curved portions bent at a second curvature from the second flat portion, and a second corner portion between two adjacent second curved portions among the second curved portions, and
the first curvature of each first curved portion of the first curved window is smaller than the second curvature of each second curved portion of the second curved window.

19. The method according to claim 18, wherein a first height of the first curved window measured from the first flat portion is smaller than a second height of the second curved window measured from the second flat portion.

20. The method according to claim 19, wherein the first height of the first curved window is equal to or greater than about 55% and equal to or less than about 85% of the second height of the second curved window.
